(19) United States
(12) Patent Application Publication
(10) Pub. No.: US 2026/0094504 A1
(43) Pub. Date: Apr. 2, 2026

(54) CONNECTED GAMING USING A MULTI-GAMING DEVICE ARCHITECTURE

(71) Applicant: Aristocrat Technologies, Inc., Las Vegas, NV (US)

(72) Inventors: Jeremiah O’Hara, Las Vegas, NV (US); Anthony Patton, Las Vegas, NV (US); James King, Las Vegas, NV (US); Samarth Raman, Las Vegas, NV (US); Keith Wood, Las Vegas, NV (US); Lattamore Osburn, Las Vegas, NV (US)

(21) Appl. No.: 19/300,476

(22) Filed: Aug. 14, 2025

Related U.S. Application Data
(60) Provisional application No. 63/701,453, filed on Sep. 30, 2024.

(51) Int. Cl. G07F 17/32

(52) U.S. Cl. CPC G07F 17/3276; G07F 17/3262

(57) ABSTRACT

This disclosure concerns the implementation of connected gaming processes for electronic devices. Disclosed herein are schemes to establish an interconnected gaming platform composed of electronic gaming machines (EGMs), “on-board” controllers (OBCs), and/or signage servers, which emphasizes shared experiences, synchronization, innovative prize-awarding mechanics, and reliable replay and recovery functionalities. In some embodiments, a group of peer electronic gaming devices participating in a connected gaming process may utilize a local (or remote) server device as the server and resource manager for the peer group. In other embodiments, also referred to herein as an “OBC network,” each electronic gaming device in the group of peer electronic gaming devices participating in the connected gaming process contains functionality to serve as the server and resource manager for the peer group. In an OBC network, rather than having a local/remote server device to manage connected gaming experiences, that functionality is distributed across multiple peer devices.

### TECHNICAL FIELD

The present disclosure concerns the implementation of connected gaming processes for electronic gaming devices. In particular, disclosed herein are various schemes to establish a robust, interconnected gaming platform composed of electronic gaming machines (EGMs), “on-board” controllers (OBCs), and/or signage servers, which emphasizes shared and synchronized experiences, innovative prize-awarding mechanics, and reliable replay and recovery functionalities.

### BACKGROUND

Electronic gaming devices, such as electronic gaming machines (EGMs), computers, or other mobile devices, can provide a variety of wagering games, such as slot games, video poker games, video blackjack games, roulette games, video bingo games, keno games and other types of games that are frequently offered at casinos and other locations. Play on electronic gaming devices typically involves a player establishing a credit balance by inputting money, or another form of monetary credit and placing a monetary wager (from the credit balance) on one or more outcomes of an instance (or single play) of a primary or base game.

In some games, a progressive jackpot (or other form of “progressive” prize) may be established that grows over time, e.g., based on player wager activity within the game. In addition to wager-based incrementing of progressive jackpots, other types of “free-to-play” progressive jackpots may also be included in EGM-based gaming environments.

Traditionally, the progressive “controller” for a set of EGMs (also referred to herein as a “bank” of EGMs) comprises a set of services that runs on dedicated servers/hardware and provides progressive functionality (e.g., tracking and administering various progressive jackpots and their current values) for a large number of EGMs.

Thus, it would be desirable to have a scheme for administering progressive prizes or other types of “connected gaming” processes (such as shared gaming experiences, shared leaderboards, shared multimedia experiences, etc.) that uses a Connected Gaming Data API that eliminates the need for customized (e.g., per-game) server plugins and allows the gaming logic for the “connected games” or “connected gaming experiences” to be located entirely on the client/gaming device side (if so desired). Such schemes may advantageously be able to help to reduce the cost of running progressive prizes (or other types of connected gaming experiences) for smaller banks of games, as well as provide additional fault tolerance and data redundancy for the progressive prizes.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game, in accordance with various implementations described herein.

FIG. 4 illustrates, in block diagram form, an exemplary group of peer electronic gaming devices participating in a connected gaming process and using a local server device as the server and resource manager for the peer group, in accordance with various implementations described herein.

FIG. 5 illustrates, in block diagram form, an exemplary group of peer electronic gaming devices participating in a connected gaming process, wherein each electronic gaming device contains functionality to serve as the server and resource manager for the peer group, in accordance with various implementations described herein.

FIG. 6 illustrates, in block diagram form, an exemplary message routing setup for group of peer electronic gaming devices hosting a distributed on-board controller, in accordance with various implementations described herein.

FIG. 7 is a flowchart illustrating an example method for performing an embodiment of the disclosed technology related to establishing an interconnected gaming platform composed of peer electronic gaming devices, in accordance with various implementations described herein.

FIG. 8A is a flowchart illustrating an example of a synchronizing timer implementation, in accordance with various implementations described herein.

FIG. 8B is a flowchart illustrating an example of publishing object updates, in accordance with various implementations described herein.

FIG. 9 is a flowchart illustrating an example of a timer synchronization between a server and a peer group of machines, in accordance with various implementations described herein.

### DETAILED DESCRIPTION

### I. INTRODUCTION

### I.A. Overview

The present disclosure concerns a novel gaming architecture that provides connected gaming functionality, e.g., for a distributed, on-board bank controller (OBC) network for electronic gaming machines (EGMs) or other configurations of peer EGMs. Specifically, the novel gaming architecture uses a “Connected Gaming Data” API that allows for no custom server plugins to be needed for each connected gaming experience—and, instead, for the gaming logic related to the connected gaming experiences to sit entirely on the client/gaming device side.

As introduced above, a “progressive jackpot” or, more simply, a “progressive,” as used herein, refers to a jackpot or other form of prize that may be awarded in a gaming environment and whose value (e.g., monetary and/or non-monetary value) grows or “progresses” over time, based on one or more of the following: player activity, amount of money wagered, and/or other randomly-determined events that may occur during a player's gameplay. As may be appreciated, progressive jackpots are merely one example of a type of feature that may be included and managed as part of a connected gaming experience.

So-called “local controller” devices, such as progressive jackpot controllers, may be capable of managing numerous jackpot games at one time, wherein each progressive jackpot that is being managed may be assigned a unique progressive jackpot ID. Each progressive jackpot may also be associated with its own set of properties, such as incremental rate, jackpot reset values, and auto-approve limits (i.e., an amount under which funds may be distributed immediately to the player). With these identifiers and properties, the progressive jackpot controller can simultaneously track, monitor, and award multiple jackpot prizes to different gaming devices and players, e.g., across different gaming ecosystems and/or different designated games, so long as they have registered their progressives with the progressive jackpot controller(s).

According to some implementations, when EGMs on a connected bank are enabled to use a distributed OBC network, the EGMs in the connected bank will automatically discover each other and form a “cluster” or “progressive cluster,” also referred to herein as a “peer group” of EGM devices.

Traditionally, a local controller device is connected to a bank of EGMs. In some instances, the local controller device acts as a server and a resource manager. As an example, certain shared resources, such as leaderboards or signage, could be managed by the local controller. However, as EGM banks shift from utilizing a dedicated local controller device to utilize OBCs and/or wide area networks (WANs), a new gaming architecture is needed to manage such shared resources and/or provide connected gaming functionality (e.g., leaderboards, tournaments, and other community gaming experiences).

According to some implementations of an OBC network, once a peer group discovery process is complete, the EGMs will “elect” one of the EGMs in the cluster to be the “leader” device and serve as the actual (i.e., currently active) local controller for the peer group, i.e., to facilitate messaging and synchronize data across the peer group. If the elected leader fails, another peer EGM may be elected to server as the leader and provide the “leader” functionality. Simultaneously, one or more EGMs (or other types of devices that are part of the peer group) may provide a desired connected gaming functionality, i.e., uniquely identifying an managing a shared state resource and the communication channels for the peer group pertaining thereto. (It is to be understood that the device(s) providing the connected gaming functionality may or may not be a part of the EGMs in the cluster that have been elected as a leader (or failover leader) device.)

According to some implementations, the game server logic may exist on all of the EGMs as a component of the game being played during the connected gaming process. As described above, in order to provide connected gaming functionality within the same OBC network, one of the EGMs may play the role of the game server. The game server will be agnostic as to where the server physically resides.

According to some implementations, the connected gaming architecture may rely on a so-called “Connected Gaming Data” API to manage access to a shared state resource (e.g., sitting on the OBC leader-elected server, a non-leader-elected EGM in the peer group, on a more traditional local or cloud-based server). When an EGM requests access to the shared state resource (also referred to as a “data blob”), the first such EGM requester will have a successful write operation to the shared state resource. Other EGMs that may subsequently request a write operation will get a failure, indicating that a current “owner” of the data blob already exists. This mechanism ensures that, at any given time, only one machine is designated as the game server, with roles including taking on the responsibility of processing and broadcasting any game-related messages to all connected clients.

According to some implementations, the computer or EGM that currently “owns” the data blob acts as the central game server and may handle all server-related game logic for the connected gaming session, as well as the broadcasting of events to the EGMs for gameplay and community signage (e.g., leaderboard) and/or other synchronization-related functionality. If, for any reason, the EGM assigned to be the leader goes offline or becomes unavailable for more than a predetermined period of time (e.g., 30 seconds), the other EGMs will detect this change and attempt to acquire “ownership” of the server state data blob. In the case of an OBC network implementation, one of the other eligible leader devices should assume control of the game data and server state information synchronization functionality. This failover mechanism is designed to be seamless, automatically transferring “leader” duties without game interruption. In an implementation using a local or cloud-based server (i.e., rather than an OBC network), if it is determined that no data has been received for more than the predetermined period of time from a client currently acting as owner of a shared state resource, then all available client devices could attempt to take “ownership” of the shared state resource (e.g., a “data blob”), with whichever client device has the first successful write operation becoming the new “owner. ” In some implementations, each client device calculates its own drift and latency with respect to the server/owner EGM by comparing their local clock timestamps with a timestamp broadcast from the server/owner EGM. This helps each client device synchronize itself with the server/owner's time, allowing for more seamless, time-dependent, and varied interactions between the EGMs within a peer group, including the display and/or playback of various media objects across EGMs within the peer group.

### I.B. Exemplary Embodiments and General Considerations

The innovations described herein include an electronic gaming device (EGM), the EGM comprising: one or more processors; memory; and control logic, implemented using the one or more processors and memory, configured to perform operations, comprising: executing a peer device discovery process, wherein the peer device discovery process is configured to cause discovery of a first number of electronic gaming devices that comprise a peer group. In some embodiments, the peer group elects an electronic gaming device to be a leader device and serve as a local controller for the peer group, and the peer group is configured to elect another one or more electronic gaming devices of the peer group to serve as the leader device in response to the electronic gaming device initially designated as the leader failing.

The control logic of the EGM may also be configured for: executing a connected gaming process, wherein the first number of electronic gaming devices in the peer group participate in the connected gaming process, wherein executing the connected gaming process comprises at least: (1) managing access to a shared state resource; and (2) processing messages related to the connected gaming process.

According to some embodiments, the shared state resource is configured to store configuration information related to events associated with the connected gaming process.

According to some embodiments, the shared state resource is configured to be accessible by the first number of electronic gaming devices in the peer group participating in the connected gaming process.

According to some embodiments, the messages related to the connected gaming process comprise one or more of: progressive award contribution amounts; progressive award increment amounts; progressive award distribution messages; or progressive award reset messages.

According to some embodiments, the connected gaming process comprises at least one of: a shared gaming experience, a shared leaderboard, a shared progressive prize award, a tournament experience, or a shared multimedia experience.

According to some embodiments, the shared state resource is located on at least one of: the electronic gaming device; one or more of the first number of electronic gaming devices in the peer group; a remote server; or a local server.

According to some embodiments, processing messages related to the connected gaming process further comprises: performing version control on the shared state resource.

According to some embodiments, the connected gaming process further comprises: managing access to at least a second shared state resource (e.g., a copy of the shared state resource stored on a failover leader device).

According to some embodiments, game logic for the connected gaming process is implemented in a client component of the electronic gaming device.

According to some embodiments, the shared state resource comprises a state machine log, and wherein the state machine log enables replay and recovery for the connected gaming process.

According to some embodiments, the shared state resource comprises at least one of: a unique identifier (UID); a key; or a resource type.

The innovations disclosed herein further include a system comprising: one or more first electronic gaming devices; and one or more second electronic gaming devices, wherein the one or more first electronic gaming devices are programmed to: execute a peer device discovery process, wherein: the peer device discovery process is configured to cause discovery of a peer group comprising: the one or more first electronic gaming devices; and the one or more second electronic gaming devices, the peer group elects a leader device from the one or more first electronic gaming devices to serve as a local controller for the peer group, and the peer group elects another one or more electronic gaming devices of the one or more first electronic gaming devices to serve as a failover leader device in response to the leader device failing, and wherein the peer group of electronic gaming devices are programmed to: execute a connected gaming process, wherein: a first one of the one or more second electronic gaming devices is programmed to: manage access to a shared state resource, wherein the shared state resource is identifiable by any electronic gaming device in the peer group; and process messages related to the connected gaming process.

According to some such embodiments, any device that is a member of the peer group can create and/or claim ownership of a shared state resource related to a connected gaming process.

According to some such embodiments, the roles of the first electronic gaming devices (i.e., the “leader” group) are primarily to facilitate messaging in the peer group (e.g., point-to-point or broadcast), synchronize data among leader group members, and provide automatic failover. The role of managing access to or “owning” a shared state resource as part of a connected gaming process connected entails a specific client in the peer group (e.g., one of the first electronic gaming devices or one of the second electronic gaming devices) responsible for facilitating the specifics of the shared state resource. The role of the “owner” of a shared state resource can include uniquely identifying the shared state resource and/or the communication channels for the peer group to follow, as well as managing the data structure and definition of the shared state resource.

The innovations disclosed herein further include a method for providing a synchronized connected gaming process in a group of peer electronic devices, the method comprising: executing, at a second electronic device of the group of peer electronic devices, a client timer; receiving, at the second electronic device, a current server timer value, wherein the current server timer value is obtained from a server timer executing at a first electronic device of the group of peer electronic devices; calculating, at the second electronic device, a client timer offset value with respect to the server timer; calculating, at the second electronic device, a client timer drift value with respect to the server timer; calculating, at the second electronic device, a current network latency estimate value; calculating, at the second electronic device, a current server time estimate based, at least in part, on: a current value of the client timer; the client timer offset value; the client timer drift value; and the current network latency estimate value; and performing, at the second electronic device, a synchronized action, wherein the synchronized action comprises: accessing a shared state resource hosted at the first electronic device at a time that is based, at least in part, on the calculated current server time estimate.

According to some embodiments, the client timer offset value is calculated based, at least in part, on a comparison of a received current server timer value and a corresponding value of the client timer.

According to some embodiments, the current server timer value is received from the first electronic device at a specified time interval.

According to some embodiments, the client timer drift value is based, at least in part, on comparisons between at least two additional received current server timer values and the corresponding at least two values of the client timer.

According to some embodiments, the current network latency estimate is based on a point-to-point message timing value of a message sent from the second electronic device to the first electronic device.

According to some embodiments, the electronic device comprises at least one of: an electronic gaming device; a slot machine; an iGaming device; a mobile electronic device; an electronic signboard; or an electronic display.

According to some embodiments, calculating the current server time estimate comprises calculating the following value: a current value of the client timer-the client timer offset value +the client timer drift value-the current network latency estimate value.

According to some embodiments, the shared state resource comprises at least one of: a unique identifier (UID); a key; or a resource type.

According to some embodiments, the first electronic device is located in a land-based casino environment, and wherein the second electronic device comprises a mobile, Internet-enabled device.

The innovations disclosed herein can be implemented by one or more devices, or performed as part of a method, e.g., involving a group of electronic gaming devices (such as an EGM) and/or a network switch, cloud-based server, or other components(s) configured to assist in performance of the claimed methods. The innovations may also be embodied on non-transitory computer-readable media storing computer-executable instructions for causing one or more processors in a computer system to perform the disclosed methods.

The various innovations can be used in combination or separately. This high-level summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples.

Examples may also be capable of other and different applications, and some details may be modified in various respects—all without departing from the spirit and scope of the disclosed innovations. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense. Rather, the scope of the present disclosure is defined by the appended claims.

### II. Example Electronic Gaming Servers and Electronic Gaming Machines or Devices

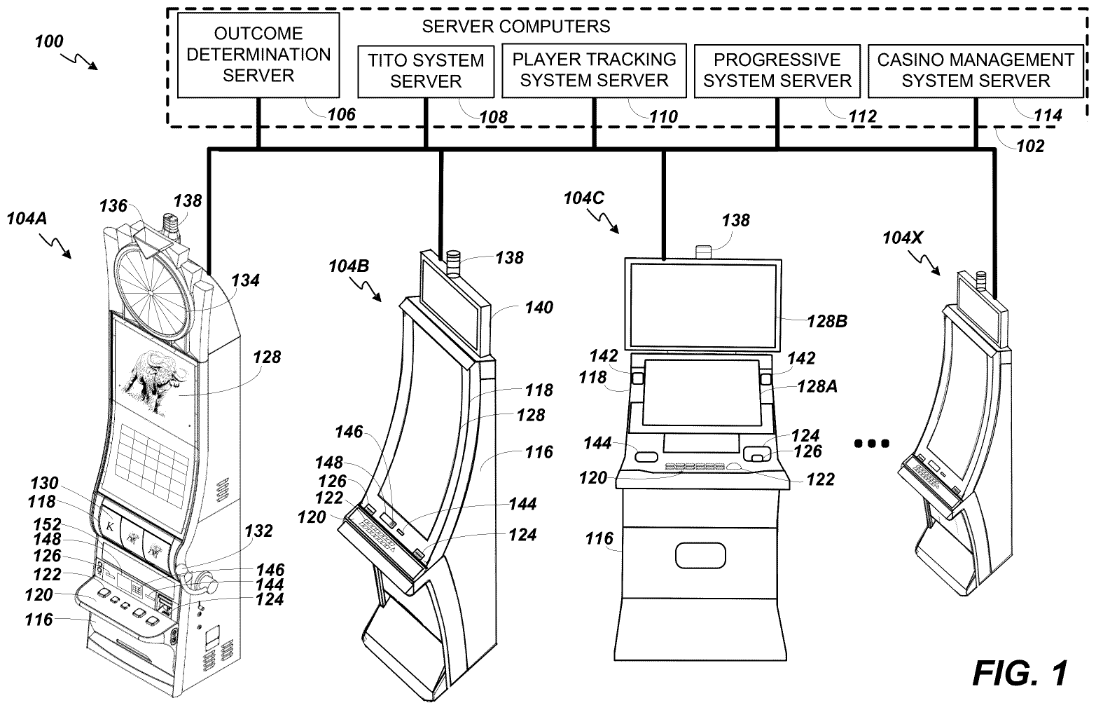

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.), which server computers 102 can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet, through a website maintained by a computer on a remote server, or over an online data network, including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure while connected locally to a machine hosting the aforementioned gaming platform. In some such cases, the local machine(s) hosting the gaming platform may be within the gaming device 104. However, it is typical to find multiple electronic gaming devices connected to networks implemented with one or more of the different server computers 102 described herein.

### II.A. Example Server Computers.

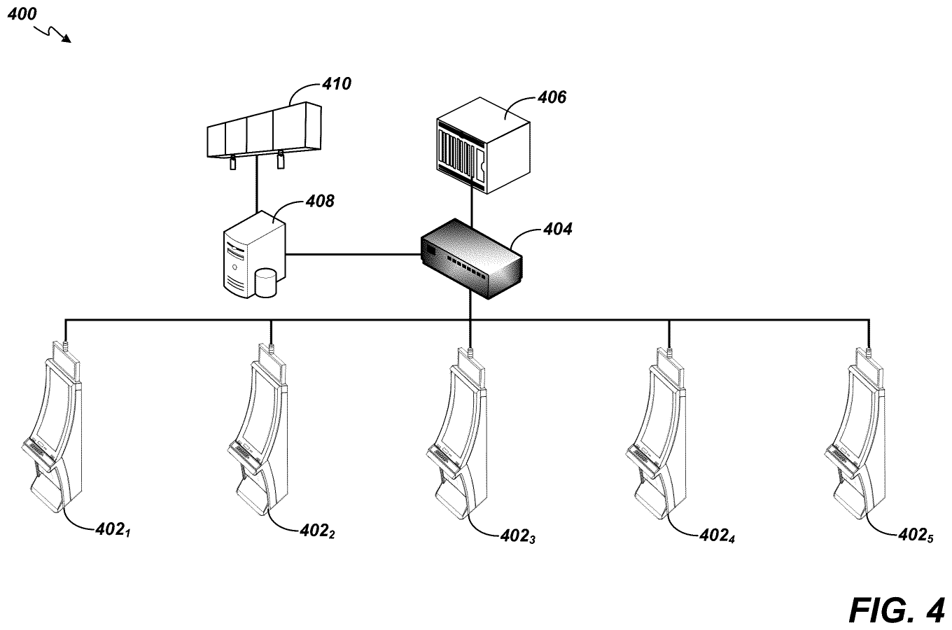

The server computers 102 may include an outcome determination server 106, e.g., a central determination gaming system server, a multimedia content distribution server, or other type of backend server (examples of which will be discussed in greater detail below), a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on an outcome determination server 106 and then transmitted over the network to any of a group of remote terminals or remote gaming devices 104A-104X that utilize the game outcomes and display the results to the players. Additional features of an improved progressive system server 112 comprising a flexible progressive jackpot system, which may, e.g., be hosted in a cloud-based environment—rather than being located on-site at a land-based casino, as progressive system server 112 shown in FIG. 1 is—will be described in further detail below, e.g., with reference to FIG. 4 et seq.

### II.B. Example Gaming Devices

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

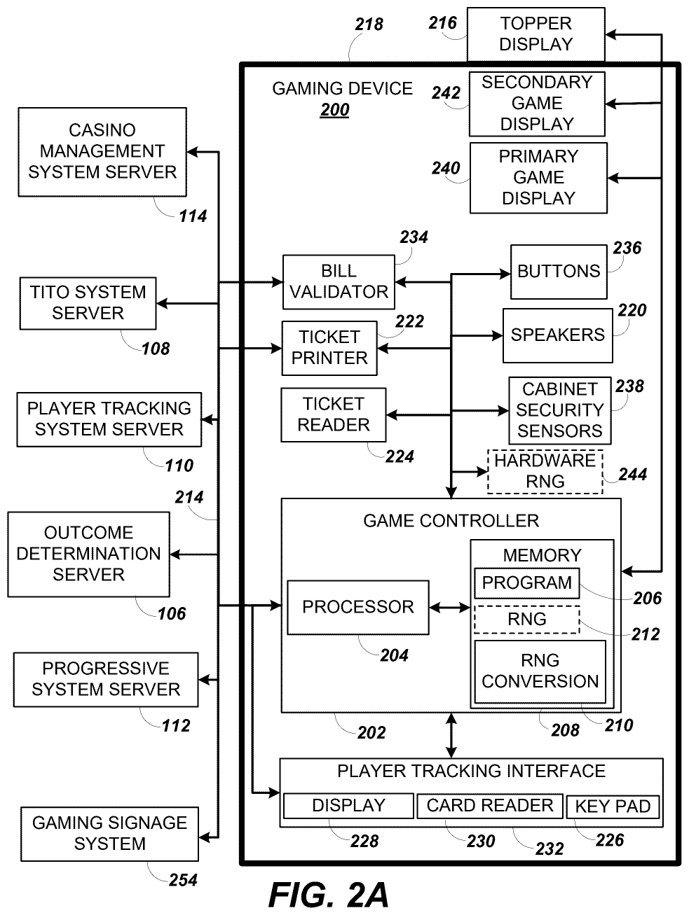

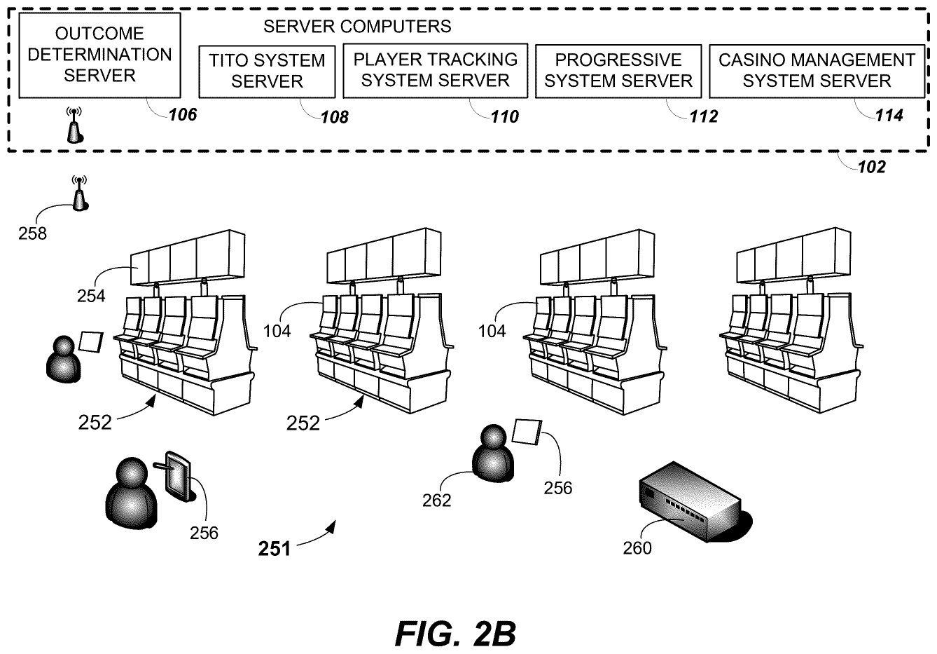

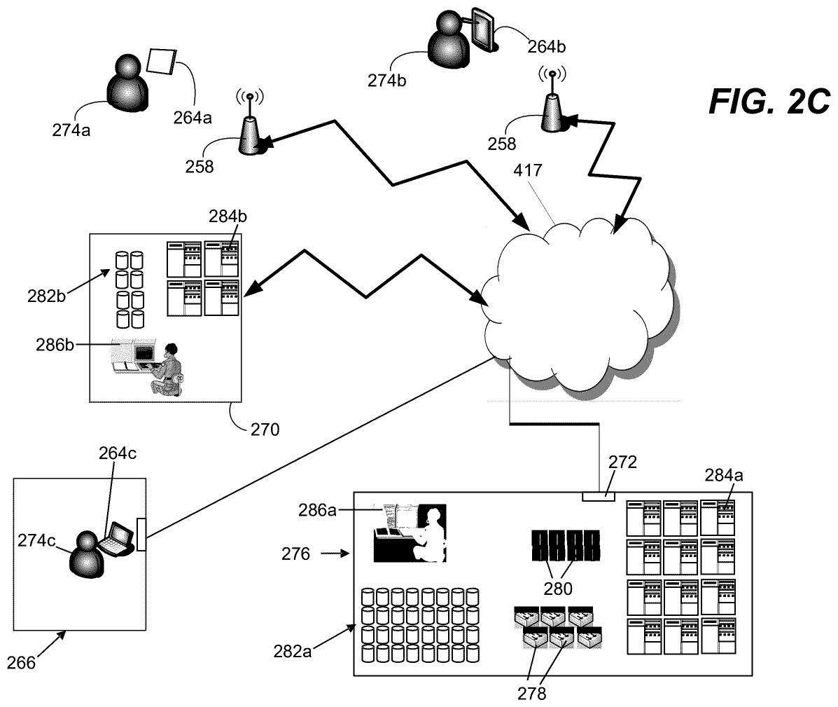

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

### II.C. Example Components of Gaming Devices

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as an outcome determination server 106 (also shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200.

In some embodiments, the outcome determination server 106 may comprise a multi-threaded architecture, allowing multiple connections and/or game instances to utilize the outcome determination server 106. In some implementations, e.g., wherein the outcome determination server 106 is hosted at a cloud service provider, the amount of resources at the cloud service provider that are dedicated to a particular game (e.g., number of servers, number of threads, amount of memory, bandwidth, etc.) may be scaled dynamically to accommodate the real-time needs of the hosted game. When a game is stored on gaming device 200, it may be loaded from memory 208 (e.g., from a read only memory (ROM)) or from the outcome determination server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features. It is to be understood that, in certain embodiments, one or more of the functions described above as being performed by game controller 202 (e.g., the RNG functionality, game program storage and/or execution, etc.) may also be performed in whole, or in part, by a hosted server platform, such as outcome determination server 106 or other servers. As will be explained in more detail below, in some embodiments, a client/server architecture may be employed with a game front end application passing requests and other information to a game backend layer, via an application service layer.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

### II.D. Example Gaming Environment

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258. In other examples, the mobile gaming devices 256 may also be configured for communication with one or more other devices external to the casino 251, e.g., players located elsewhere in a particular city, elsewhere in a particular state, at a particular casino's other locations, and so forth. Additional details regarding the use of devices, e.g., Internet of Things (IoT) devices as jackpot controllers and/or jackpot collection devices for banks of EGMs may be found in commonly-assigned U.S. patent application Ser. No. 17/857,988, filed Jul. 5, 2022, and entitled, “Data Collection Cloud System for Electronic Gaming Machines” (hereinafter, “the '988 application”), which is hereby incorporated by reference in its entirety.

According to some examples, the mobile gaming devices 256 may be configured for stand-alone determination of game outcomes. However, in some alternative implementations the mobile gaming devices 256 may be configured to receive game outcomes from another device, such as the outcome determination server 106, progressive system server 112, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

### II.E. Example Distributed Gaming Delivery

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272, including and one or more workstations 286a. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers. In still other examples, as will be explained in further detail below, one or more third party cloud-based service providers may be utilized by a given casino, a given game developer, or given game studio to host backend game functionality for a number of different games (and/or a number of different players) simultaneously, according to a general service architecture and flexible backend platform design implementing a novel GDK to enhance and componentize game development.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

### II.F. Example Game Processing Architecture

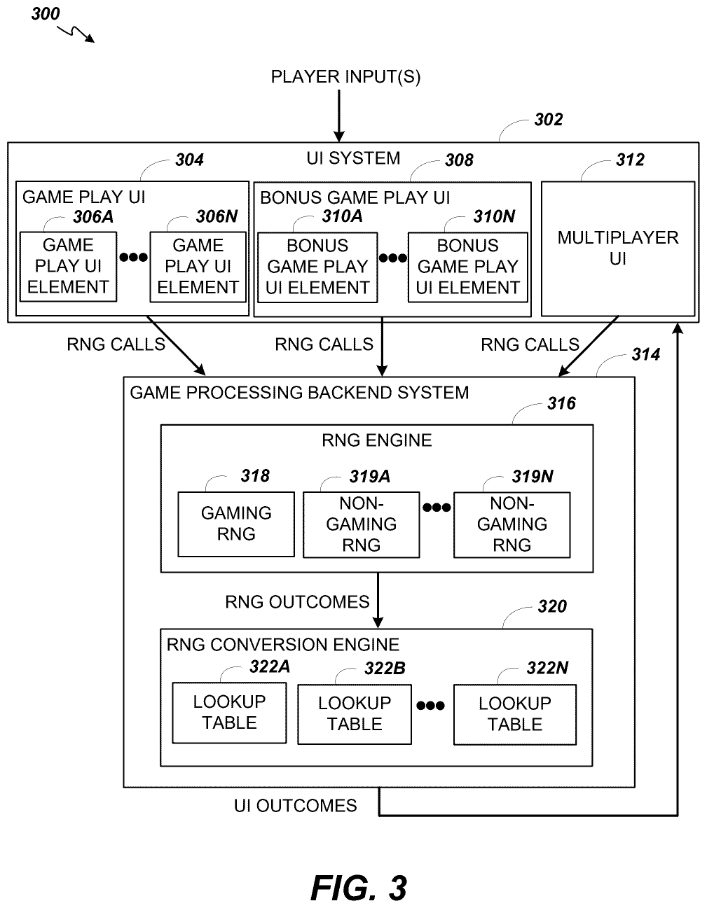

FIG. 3 illustrates, in block diagram form, an implementation of a traditional, i.e., non-hosted, game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, as will be discussed in further detail below, portions of the gaming processing architecture 300 can implement the game processing pipeline using a gaming device and one or more remote gaming devices, such as outcome determination server 106 shown in FIG. 1. In such implementations, the game processing pipeline may also utilize one or more game service clients, e.g., to pass inputs and requests between the gaming device/gaming application and the backend gaming system server that is hosting aspects of the game's functionality.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. (As mentioned above, in embodiments wherein aspects of the game's functionality are hosted by a backend server, the UI outcomes may be determined by the hosted game backend and then returned to the game via an application service layer so that the game application may update the appropriate audio and/or visual gameplay elements.) Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In yet another example, the UI outcome may reflect updating a visual display element (e.g., a virtual meter) with an updated progressive jackpot value. In response to updating the appropriate UI, the player may subsequently provide additional player inputs to initiate a subsequent game instance that progresses through the game processing pipeline.

### III. EXAMPLE EMBODIMENTS

### III.A. A Connected Gaming Architecture for a Group of Peer Electronic Gaming Devices

In the land-based/casino environment, casinos typically install specialized local controllers, such as jackpot controller hardware, to accurately track, monitor, and store information related to connected gaming experiences (e.g., progressive jackpot prizes, or the like) in a closed-loop network. Such hardware local controllers are typically specially configured to perform functionality that is often required by stringent gaming regulations.

As an example, in the case of a community progressive jackpot, the progressive jackpot values must be accurate and need to be subject to a high degree of auditability. Specifically, each contributor to a progressive must have an accurate progressive money wagered meter that can be reconciled for each jackpot that is triggered (i.e., awarded to a particular player).

In other implementations, a distributed network of on-board controllers (OBCs) for administering progressive jackpots or other shared/synchronized information types may be employed, that does not require the dedicated servers/hardware typically needed to provide community gaming-related functionality for large numbers of EGMs.

The embodiments disclosed herein may advantageously help to reduce the cost and/or regulatory burden of running progressives or other shared/synchronized information types for smaller banks of games, as well as provide additional fault tolerance and data redundancy, e.g., in the event that an EGM within the bank of connected EGMs that was currently serving as the “owner” of the server data blob becomes unavailable for greater than a threshold amount of time (e.g., going offline or powering down).

According to some embodiments, the game server logic will exist on all of the EGMs in a peer group as a component of the game, and one of the EGMs will act as the game server. Compared with prior art approaches, because there is no need for dedicated hardware for the on-board controller services (e.g., progressive jackpot-related services) and the EGMs themselves can host the services and server logic, and the redundancy and fault tolerance is “built in” to the framework using distributed technology.

According to some embodiments, the so-called “Connected Gaming Data” APIs may be designed, such that techniques developed for dedicated hardware jackpot controller-based solutions can also be used for OBC-based or WAN-based versions of a connected gaming process. Preferably, no custom server plugins need to be developed for the connected gaming architectures disclosed herein. Instead, the game logic is implemented entirely in the EGM clients. The platform's protocol configuration can determine if the Connecting Gaming Data API is using an OBC-based or hardware controller-based protocol. In other words, the protocol and infrastructure will be transparent to the EGM game.

Another advantageous aspect of the connected gaming architectures disclosed herein is the linked functionality they provide. The linked functionality aims to foster collective engagement from multiple players at once. It brings shared bonuses, synchronized modes, and progressive features, expanding beyond the standard jackpot experience. The disclosed functionality also allows games to revolutionize the way prizes are distributed, e.g., providing novel shared outcome designs.

Finally, the connected gaming architecture allows for robust replay and recovery mechanisms to be implemented. These features address potential disruptions, such as communication losses, ensuring that gameplay can be resumed seamlessly. Moreover, detailed logs and recall functionalities will be implemented to resolve potential player disputes, maintain transparency, and meet regulatory requirements.

Turning now to FIG. 4, an exemplary group of peer electronic gaming devices (402₁-402₅) participating in a connected gaming process and using a local server device (e.g., jackpot controller 406) as the server and resource manager for the peer group 400 are illustrated, in block diagram form, and in accordance with various implementations described herein. In the implementation of the connected gaming architecture shown in FIG. 4, the jackpot controller 406 will always act as the server and resource manager, while the network switch 404 will route data packets between electronic gaming devices 402 and jackpot controller 406, as well as to an optional media server 408, which, as shown in FIG. 4, may be connected to electronic signage 410, e.g., for displaying a community leaderboard, synchronized media content, or the like. In the configuration of FIG. 4, a jackpot controller 406 server plugin will implement any game server functionality that may be required for the bank of EGMs 402₁-402₅.

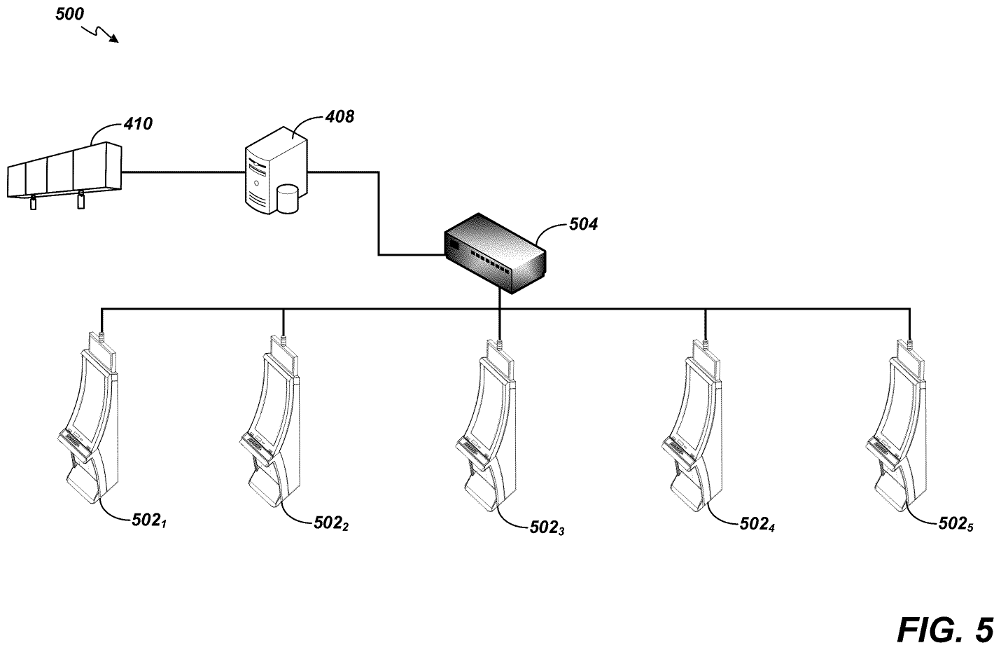

Turning now to FIG. 5, an exemplary group of peer electronic gaming devices (502₁-502₅) participating in a connected gaming process, wherein each electronic gaming device contains functionality (e.g., via an OBC) to serve as the server and resource manager for the peer group 500 are illustrated, in block diagram form, and in accordance with various implementations described herein. In the OBC-based implementation of the connected gaming architecture shown in FIG. 5, each of the EGMs 502 will potentially contain the functionality for the server component (e.g., the data blob storage and message routing capabilities described herein). The elected OBC “leader” EGM will not necessarily be the same EGM that is providing the game server functionality at a given moment in time. In other words, these two concepts are independent from one another in example 500. In the implementation shown in FIG. 5, one or more OBC switches 504 will route data packets between electronic gaming devices 502, as well as to an optional media server 408, which, as shown in FIG. 5, may be connected to electronic signage 410, e.g., for displaying a community leaderboard, synchronized media content, or the like. In the configuration of FIG. 5, no server plugins need to be developed, as the game logic is implemented entirely in the EGM 502₁-502₅ clients.

As mentioned above, other embodiments, such as those operating over a wide area network (WAN) are also possible, wherein, e.g., the jackpot controller is implemented in the cloud.

### Iii. B. Exemplary Message Routing Functionality for a Group of Peer Electronic Gaming Devices Hosting a Distributed On-board Controller

According to some embodiments, the OBC component may maintain a document of information in its storage component, which will have the details of all the active progressives and/or other community gaming-related information. Since the querying and formatting of this data can be resource intensive, according to some embodiments, there may be a separate OBC service, which can query this data from the progressive controller on the leader EGM and then format it for reporting and/or provide it to a message router, e.g., to send to another EGM device.

Examples of the types of reports that an OBC reporting service may be capable of producing include:
(1) Progressive configuration report: This report will contain the configuration information about all the active progressives.
(2) Active progressive report: This report will contain the current and cumulative values of all the active jackpots with information about the participating EGMs.
   Other types of reports are also possible, based on the needs of a given implementation, e.g., reports that relate to community leaderboards, shared gaming experiences, such as tournaments, shared multimedia experiences, events, etc., rather than progressive awards. Additional details regarding the exemplary components of (and communications between) electronic gaming devices in a peer group using OBCs may be found in the commonly-assigned, co-pending U.S. Patent Application filed Apr. 3, 2024 and having Ser. No. 18/625,558, entitled “Automatic On-Board Controllers for Electronic Gaming Devices” (hereinafter, “the '558 application”). The '558 application is hereby incorporated by reference in its entirety.

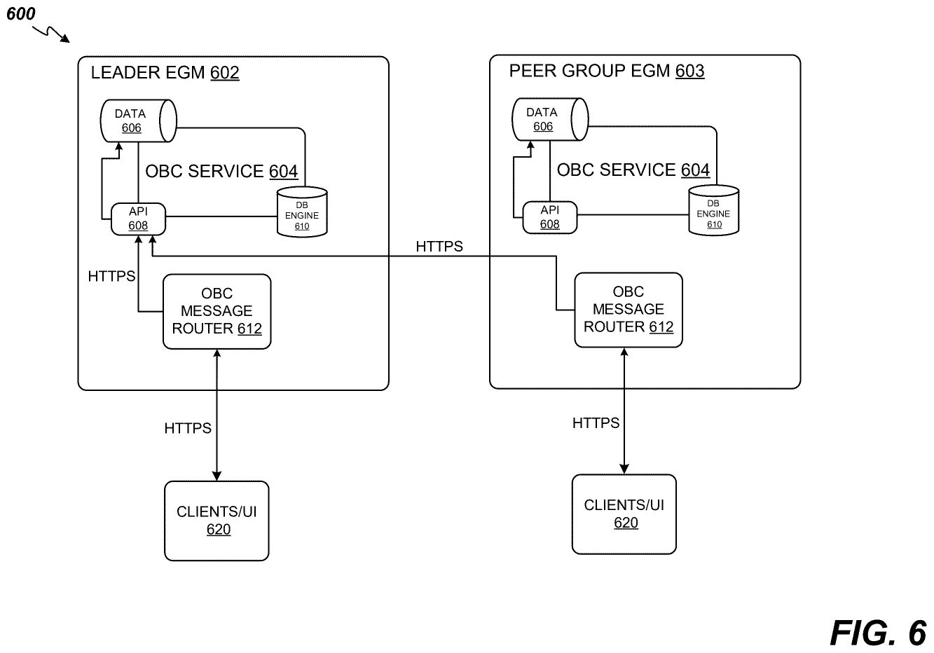

Turning now to FIG. 6, a block diagram 600 illustrating an exemplary message routing setup for group of peer electronic gaming devices hosting a distributed on-board controller is shown, in accordance with various implementations described herein. A leader EGM 602 may comprise an EGM that has been elected to be the server that, e.g., facilitates messaging in the peer group (e.g., point-to-point or broadcast messaging), synchronizes data among any other EGMs that have been elected as potential failover leaders (i.e., the so-called “leader group”), and provides automatic failover protection. Exemplary leader EGM 602 may further comprise: an OBC service 604, which can comprise: a data storage component (e.g., a database) 606, a database engine (e.g., SQLite) 610, and one or more API (608), such as a “Connected Gaming Data” API, which may be used to configure and query community gaming-related data and/or manage access to a shared state resource, as may be requested or reported via an OBC message router (612). According to some embodiments, OBC message router 612 may be used to broker, i.e., route, community gaming-related message objects to a client device and/or user interface 620, e.g., via HTTPS or other secure communication protocol.

According to some embodiments, the OBC message router 612 may pull the data from an on-board controller service API 608 and then place the relevant data in a message object that may be routed to the appropriate destination(s). If desired, the OBC message router 612 may be configured to filter and/or otherwise inspect the content of messages before their transmission, e.g., to determine whether a given message is to be send to a particular client/channel or is to be broadcast to all clients/channels that have been established with the message router.

EGM 603 represents an exemplary peer group EGM that is in the same peer group of electronic devices as current leader EGM 602. As may now be appreciated, even though EGM 603 is not currently the leader of the peer group (or a part of the “leader group” of EGMs in the peer group that are capable to serve as leader in the event of failover of current leader EGM 602), peer group EGM 603 may nonetheless create and/or claim “ownership” of a connected gaming resource, also referred to herein as a “shared state resource. ” Owning a connected gaming shared state resource makes a specific client in the peer group (e.g., EGM 603, in this example) responsible for facilitating the specifics of that shared state resource. This can include uniquely identifying the shared state resource and the communication channels for the peer group to follow, as well as managing the data structure and definition of the shared state resource. As may now be appreciated, peer group devices may comprise traditional EGMs and slot machines, but also many other classes of devices, e.g., an iGaming device; a mobile electronic device; an electronic signboard; or an electronic display.

### III. C. Exemplary Methods for Establishing an Interconnected Gaming Platform Composed of Peer Electronic Gaming Devices

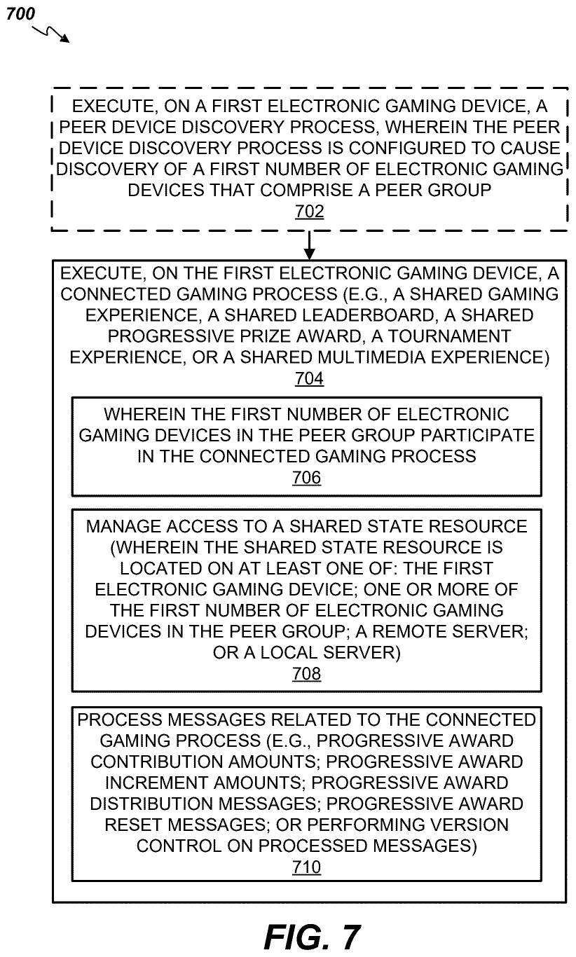

Turning now to FIG. 7, a flowchart, illustrating an example method 700 for performing an embodiment of the disclosed technology related to establishing an interconnected gaming platform composed of peer electronic gaming devices, in accordance with various implementations described herein. In particular, method 700 depicts what happens when an exemplary “first” electronic device initiates a peer group discovery process to identify EGMs on a local network to participate in a connected gaming process. In some embodiments, each EGM may host a distributed on-board controller with game server logic, e.g., for administering progressive prize awards. (It is to be understood that, in other implementations, a dedicated local server device or a remote server device may host the game server logic, i.e., rather than being hosted on one of the EGMs itself.)

First at Step 702, the method 700 may optionally execute, on a first electronic gaming device, a peer device discovery process, wherein the peer device discovery process is configured to cause discovery of a first number of electronic gaming devices that comprise a peer group. In other embodiments, e.g., if a peer group of client devices has already been established, and if a client simply wanted to write an entry for an existing leaderboard, say, it would not have to conduct an additional peer device discovery process before sending the necessary messages to update the existing leaderboard. In some embodiments, the peer group may elect one of the electronic gaming devices (e.g., the “first” electronic gaming device, in this example) to be a leader device and serve as a local controller for the peer group. In some such embodiments, the peer group may be further configured to also elect another one or more electronic gaming devices of the peer group to be a part of a “leader group,” i.e., devices that may serve as the leader device in response to the failure of the electronic gaming device that is currently serving as the leader.

Next, at Step 704, the method 700 may execute, on the first electronic gaming device, a connected gaming process (e.g., a shared gaming experience, a shared leaderboard, a shared progressive prize award, a tournament experience, or a shared multimedia experience, etc.). As explained in detail above, in some implementations for administering progressive prize awards, an OBC of the EGM currently acting as the current gaming server may be configured to: perform requested progressive award calculations for the peer group; store results of the requested progressive award calculations; and transmit the results of the requested progressive award calculations to the other electronic gaming devices in the peer group. If the current EGM providing the gaming server functionality goes offline for at least a threshold amount of time (e.g., 30 seconds), additional logic may be employed to replace that EGM with another device from the peer group, e.g., via random selection or other means. For example, the other EGMs in the peer group may detect this change in status and attempt to acquire “ownership” of the shared state resource (e.g., a data blob) sitting on an OBC server device. The OBC network then selects a new owner for the shared state resource, ensuring that the game server functionality is being executed. This failover mechanism is designed to be seamless—automatically transferring server duties without game interruption. In still other embodiments, a local controller or a remote controller accessible over a WAN may serve as the provider of the aforementioned connected gaming functionalities.

Next, at Step 706, the method 700 reflects that, as part of executing the connected gaming process at Step 704, the first number of electronic gaming devices in the peer group participate in the connected gaming process. Next, at Step 708, the method 700 reflects that, as part of executing the connected gaming process at Step 704, the first electronic gaming device may manage access to a shared state resource (wherein the shared state resource is located on at least one of: the first electronic gaming device; one or more of the first number of electronic gaming devices in the peer group; a remote server; or a local server). As may be appreciated, according to some embodiments, the first electronic gaming device may manage access to multiple shared state resources (including shared state resources of different types), that are relevant to a given connected gaming process. In order to distinguish between shared state resources, each shared state resource may comprise at least one of: a unique identifier (UID) (i.e., a server-assigned unique identifier for the particular resource); or a resource type (i.e., which allows retrieval/manipulation of a data blob based on type, e.g., if a specific UID is not known). In still other embodiments, keys may be used to manage access to different shared state resources, e.g., maintaining a data dictionary for shared state resources, where individual pieces of data are accessed via appropriate key-value pairs. For example, a known key may be used to access a shared state resource.

Shared storage allows for persistent data to be shared among clients on a shared network. Preferably, typical create, read, update, and/or delete functionality may also be provided (assuming regulatory compliance can be assured). According to some implementations, shared storage may use a row versioning mechanism to help detect conflicts between concurrent transactions. For example, when a transaction tries to modify data in a data blob, the server can compare the version number of the data with the version number of the transaction. If the version numbers do not match, the current transaction will be rolled back and converted to a read operation.

Finally, at Step 710, the method 700 reflects that, as part of executing the connected gaming process at Step 704, the first electronic gaming device may process (i.e., “broker” or route) various messages related to the connected gaming process (e.g., progressive award contribution amounts; progressive award increment amounts; progressive award distribution messages; progressive award reset messages; or performing version control on processed messages). To enable communication amongst clients on shared network, a message broker architectural pattern may be employed for message validation and routing. A message broker also allows for the decoupling of the sender and receiver of messages. According to some embodiments, for ease of implementation, the message broker functionality of the Connected Gaming Data API may be limited to publish/subscribe and send/receive functionality.

It is to be understood that, although, in the example of FIG. 7, the current leader of the peer group (i.e., the first electronic gaming device) is also executing and owning the “connected gaming process,” ownership of the connected gaming process by the leader device is not strictly necessary and, indeed, any device in the peer group may serve as owner of a particular connected gaming process (i.e., facilitating the specifics of the shared state resource(s) affiliated with the particular connected gaming process), while the leader device (and others in the leader group) are responsible for facilitating messaging in the peer group, synchronizing data between members of the leader group, and providing automatic failover protection, as described above.

Preferably, all communications within the interconnected gaming process framework will utilize message-level encryption over the Transmission Control Protocol (TCP), which is the industry standard designed to provide reliable and error-free communications over a network. Further, these services are preferably run on a separate internal network with its own switch and ports, so that it does not get exposed to the main casino floor network.

### III.D. Timer Synchronization Examples

According to some embodiments, another of the objectives of a system design is to provide a framework-style API for communication and storage that leaves business logic up to server systems, i.e., the business logic does not need to be handled by the framework itself. The definition of a “resource,” in this context (also referred to as a “data blob,” above), is an object that contains the required data to implement a particular piece of business logic or a business flow, such as a progressive jackpot value, a shared leaderboard, or the like.

A resource may be passed around between OBC server devices (e.g., EGMs) to relay commands and/or state values for that particular business flow. In the context of a distributed system, the resource/data blob object will, in most cases, need an “owner” to maintain the state and integrity of the resource. In some implementations, it may be important or necessary to have a synchronization timer concept along with the resource ownership framework. Once messages are sent and received by the various server devices (including the owner) and a timing synchronization is established, the devices can then do what is needed according to their particular business flow, e.g., launching a round of game play, displaying a video or other message across one or more of the servers, playing a sound across one or more of the servers, etc.

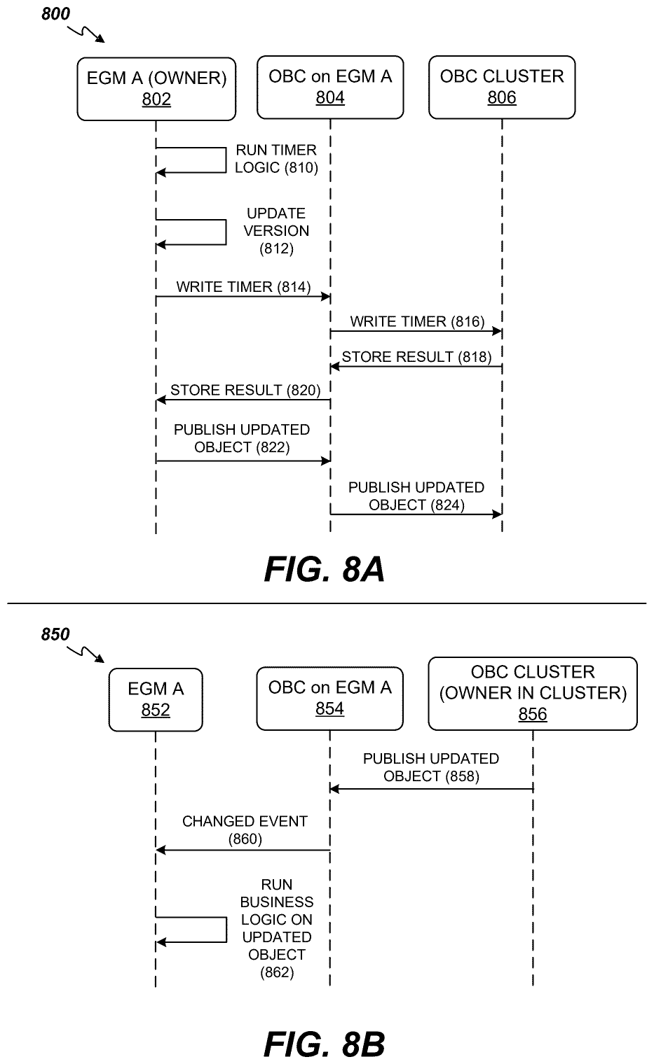

FIG. 8A is a flowchart 800 illustrating an example of a synchronizing timer implementation, in accordance with various implementations described herein. First, an exemplary EGM A 802 (which, in this example, represents the owner of the particular resource in question) may begin to run a synchronizing timer logic 810. The timer object may be updated based on the pertinent business logic, e.g., every n milliseconds. Next, if the timer object has been updated, an updated version may be created 812. At 814, the timer value may be written to the OBC on EGM A 804. (It is to be understood that, for the example of FIG. 8A, the EGM A 802 and the client OBC on EGM A 804 are shown as two different actors, but, in some implementations, the client OBC on EGM A 804 will actually be part of the server process, i.e., the EGM A 802, and these messages described in FIG. 8A will originate from the game/business logic layers.)

Next, at 816, the timer value may be written to the OBC Cluster 806, i.e., the other EGMs in the peer group for which EGM A 802 is a leader/owner. At 818, any updated results created by an EGM in the OBC Cluster 806 may then be stored back with the OBC on EGM A 804, which, in turn, at 820, may be stored back at the server EGM A 802. If the writing of the updated results at the server EGM A 802 is successful, then, at 822, the updated object may be published to the client OBC on EGM A 804 and, in turn, at 824, to the remaining devices in the OBC Cluster 806.

FIG. 8B is a flowchart 850 illustrating an example of publishing object updates, in accordance with various implementations described herein. In the example of FIG. 8B, an object change is being pushed by the owner of the resource, who happens to be in OBC cluster 856. Thus, at 858, the owner may publish the updated object to the client OBC on EGM A 854 (i.e., the equivalent to OBC 804 in FIG. 8A, wherein EGM A was the owner), which may then, at 860, send the object via a changed event message to the server EGM A 852 (i.e., the equivalent to EGM A 802 in FIG. 8A). At 862, the EGM A 852 may then process the updated object and run any necessary business logic based on the updated object, e.g., launching a round of game play, displaying a video or other message across one or more of the servers, playing a sound across one or more of the servers, etc. (It is to be understood that, for the examples of FIG. 8A and FIG. 8B, the processes are shown as being carried out by EGMs and, in particular, EGMs that are a part of a peer group cluster and that are employing the use of an OBC. However, in other implementations, the timer synchronization logic could be running on any type of device, such as a local controller device or a cloud-based server device, i.e., it would not necessarily need to be running on an OBC of a leader/“owner” device of a peer group of devices.)

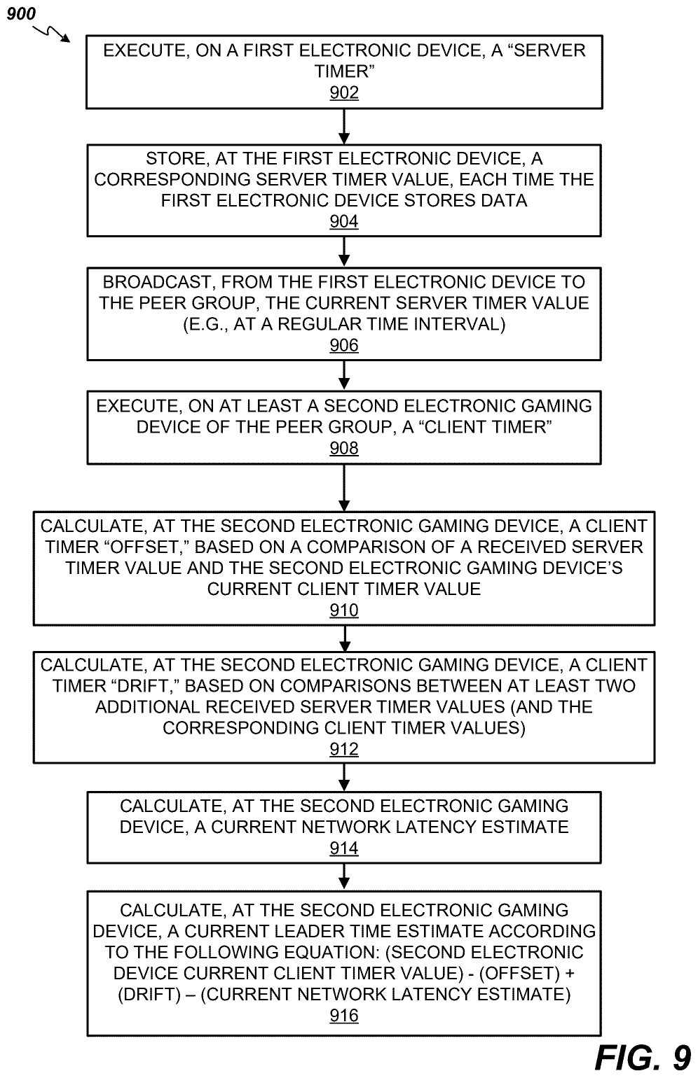

FIG. 9 is a flowchart illustrating an example method 900 of performing a timer synchronization operation between a server and a peer group of machines (e.g., various types of electronic devices or EGMs), in accordance with various implementations described herein. At Step 902, the method 900 begins by executing, on a first electronic device that is serving as a “server” within a peer group, a “server timer. ” The server timer may also be thought of as a “stopwatch” that is started any time that a new device begins serving as a server for the peer group. In other implementations, the server timer could be on another network-connected device in communication with the peer group, e.g., a local controller device or a cloud-based server device, i.e., rather than on the server device itself.

Next, at Step 904, the method 900 causes the server to store a corresponding server timer value each time that any new data is saved or stored in the relevant resource object/data blob. In some embodiments, resource/data blobs may be subscribed to by peer devices via a unique key, GUID, or other type of identifier value associated with the respective resource/data blob. According to some implementations, if the server device restarts (or a new server starts), the stopwatch timer may start again from the last saved time (with the peer devices deleting any old data received subsequently to the last saved time that the group will be reverting to).

Next, at Step 906, the server may broadcast the current server timer value to the peer group, e.g., at a regular interval, such as every second, every 5 seconds, etc. This type of broadcast may also be referred to as a “heartbeat,” or a “metronome,” or the like. As peer devices may later join (or leave) the peer group, they may simply obtain the latest server time value from the appropriate server timer resource.

At Step 908, at least one second electronic device of the peer group that is not serving as the server (i.e., a “client” or “follower” device) may execute its own stopwatch timer, also referred to herein as a “client timer. ” However, such a client timer cannot give an accurate estimate of when an event of interest takes place unless it can connect to the server device of the peer group. Thus, at 910, the second electronic device of the peer group may calculate a client timer “offset,” i.e., based on a comparison of a received server timer value and the second electronic device's current client timer value. In some embodiments, the second electronic device can calculate the offset from taking its own recorded timestamp value minus a received timestamp value from the server device of the peer group.

Next, at Step 910, the second electronic device may calculate a client timer “drift” value, e.g., based on comparisons between at least two additional received server timer values (and the corresponding client timer values). According to some implementations, each client electronic device may keep up to a predetermined configurable number of drift calculations (e.g., 10, 50, 100, etc.) and average them (e.g., via a rolling average calculation) to calculate an average drift value for the particular client second electronic device.

Next, at Step 912, the second electronic device may calculate a current network latency estimate. In some implementations, the network latency estimate value may be calculated by timestamping the message send and receive times for known messages, with very minimal additional processing (e.g., dividing by two to convert from a round-trip time to a one-way latency estimate). As with the drift calculations described above, according to some implementations, each client electronic device may keep up to a predetermined configurable number of latency calculations (e.g., 10, 50, 100, etc.) and average them (e.g., via a rolling average calculation) to calculate an average network latency estimate value for the particular client second electronic device.

Finally, at Step 914, the second electronic device may calculate a current server time estimate. According to some implementations, the following equation may be used: second electronic device current client timer value (i.e., from Step 908)−offset (i.e., from Step 910)+drift (i.e., from Step 912)−current network latency estimate (i.e., from Step 914).

As may now be appreciated, method 900 allows any synchronized client device to calculate and determine corresponding “timer” values between itself and the server device, such that the server device could instruct the client devices to take a particular action at a particular server device timestamp (or at a time offset therefrom by a specified amount of time), display or use a value corresponding to a particular server device timestamp, etc. For some business processes, e.g., shared progressive jackpots or the like, synchronization between peer devices within, say, 5 seconds may be sufficient synchronization precision. However, for other business processes, e.g., synchronized audio, it may be important to achieve much higher synchronization precision (e.g., within 10 milliseconds) between the peer devices. As described above with reference to FIG. 8A and FIG. 8B, in the example of FIG. 9, the processes are shown as being carried out by EGMs and, in particular, EGMs that are a part of a peer group cluster. However, in other implementations, the timer synchronization logic could be running on any type of device, such as a local controller device or a cloud-based server device, i.e., it would not necessarily need to be running on a device of a peer group of devices.

According to still other implementations, timer synchronization operations could also be performed across ecosystems, e.g., a land-based device synchronizing with an Internet-based device, or the like. In such implementations, a backend server could be utilized, which each client device (i.e., across ecosystems) could synchronize to, e.g., via a network connection. Such a cross-ecosystem synchronization operation could, e.g., allow for the synchronization of leaderboard, jackpot values, etc., between online-based players and land-based players at the same time, thereby enhancing the number and types of gaming settings that can benefit from the timer synchronization techniques disclosed herein.

One technical benefit of the timer synchronization framework and infrastructures disclosed herein is that game developers will be able to synchronize various elements of their gaming experiences without hardcoding changes at multiple levels of the infrastructure. In other words, this generic model approach supports more creative implementations by game developers. In some implementations, client libraries may be provided to game developers that automatically handle synchronization calculations. Game developers can then use such libraries to implement synchronization in their games, building new gaming experiences that rely on or leverage accurate synchronization between devices, as well as robust failover and recovery functionalities.

### Iv. ALTERNATIVES, VARIATIONS, AND CONCLUSION

Numerous embodiments are described in this disclosure and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget. ” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget”” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget”does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and they may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only and are not to be taken as limiting the disclosure in any way.

For the sake of presentation, the detailed description uses terms like “determine” and “select” to describe computer operations in a computer system. These terms denote operations performed by a computer and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to ensure privacy and prevent fraud in any of a variety of ways well known in the art.

It will be readily apparent that the various methods and algorithms described herein may be implemented by, e.g., appropriately programmed general-purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but they may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device, comprising:
one or more processors;
memory; and
control logic, implemented using the one or more processors and memory, configured to perform operations, comprising:
executing a peer device discovery process, wherein:
the peer device discovery process is configured to cause discovery of a first number of electronic gaming devices that comprise a peer group,
the peer group elects the electronic gaming device to be a leader device and serve as a local controller for the peer group, and
the peer group is configured to elect another one or more electronic gaming devices of the peer group to serve as the leader device in response to the electronic gaming device failing; and
executing a connected gaming process, wherein the first number of electronic gaming devices in the peer group participate in the connected gaming process, and wherein executing the connected gaming process comprises:
managing access to a shared state resource, wherein the shared state resource is identifiable by the first number of electronic gaming devices that comprise the peer group; and
processing messages related to the connected gaming process.

2. The electronic gaming device of claim 1, wherein the shared state resource is configured to: store configuration information related to events associated with the connected gaming process.

3. The electronic gaming device of claim 1, wherein the shared state resource is configured to be accessible by the first number of electronic gaming devices in the peer group participating in the connected gaming process.

4. The electronic gaming device of claim 1, wherein the messages related to the connected gaming process comprise one or more of: progressive award contribution amounts; progressive award increment amounts; progressive award distribution messages; or progressive award reset messages.

5. The electronic gaming device of claim 1, wherein the connected gaming process comprises at least one of: a shared gaming experience, a shared leaderboard, a shared progressive prize award, a tournament experience, or a shared multimedia experience.

6. The electronic gaming device of claim 1, wherein the shared state resource is located on at least one of: the electronic gaming device; one or more of the first number of electronic gaming devices in the peer group; a remote server; or a local server.

7. The electronic gaming device of claim 1, wherein processing messages related to the connected gaming process further comprises: performing version control on the shared state resource.

8. The electronic gaming device of claim 1, wherein the connected gaming process further comprises:
managing access to at least a second shared state resource.

9. The electronic gaming device of claim 1, wherein game logic for the connected gaming process is implemented in a client component of the electronic gaming device.

10. The electronic gaming device of claim 1, wherein the shared state resource comprises a state machine log, and wherein the state machine log enables replay and recovery for the connected gaming process.

11. The electronic gaming device of claim 1, wherein the shared state resource comprises at least one of: a unique identifier (UID); a key; or a resource type.

12. A method for providing a connected gaming process for a group of peer electronic gaming devices, the method comprising:
executing, on a first electronic gaming device, a peer device discovery process, wherein:
the peer device discovery process is configured to cause discovery of a first number of electronic gaming devices that comprise a peer group,
the peer group elects the first electronic gaming device to be a leader device and serve as a local controller for the peer group, and
the peer group is configured to elect another one or more electronic gaming devices of the peer group to serve as the leader device in response to the first electronic gaming device failing; and
executing, on the first electronic gaming device, a connected gaming process, wherein the first number of electronic gaming devices in the peer group participate in the connected gaming process, and wherein executing the connected gaming process comprises:
managing access to a shared state resource, wherein the shared state resource is identifiable by the first number of electronic gaming devices that comprise the peer group; and
processing messages related to the connected gaming process.

13. The method of claim 12, wherein the shared state resource is configured to be accessible by the first number of electronic gaming devices in the peer group participating in the connected gaming process.

14. The method of claim 12, wherein the connected gaming process comprises at least one of: a shared gaming experience, a shared leaderboard, a shared progressive prize award, a tournament experience, or a shared multimedia experience.

15. The method of claim 12, wherein the shared state resource is located on at least one of: the first electronic gaming device; one or more of the first number of electronic gaming devices in the peer group; a remote server; or a local server.

16. The method of claim 12, wherein processing messages related to the connected gaming process further comprises: performing version control on the shared state resource.

17. A system, comprising:
one or more first electronic gaming devices; and
one or more second electronic gaming devices,
wherein the one or more first electronic gaming devices are programmed to:
execute a peer device discovery process, wherein:
the peer device discovery process is configured to cause discovery of a peer group comprising: the one or more first electronic gaming devices; and the one or more second electronic gaming devices,
the peer group elects a leader device from the one or more first electronic gaming devices to serve as a local controller for the peer group, and
the peer group elects another one or more electronic gaming devices of the one or more first electronic gaming devices to serve as a failover leader device in response to the leader device failing, and
wherein the peer group of electronic gaming devices are programmed to:
execute a connected gaming process, wherein:
a first one of the one or more second electronic gaming devices is programmed to:
manage access to a shared state resource, wherein the shared state resource is identifiable by any electronic gaming device in the peer group; and
process messages related to the connected gaming process.

18. The system of claim 17, wherein the connected gaming process comprises at least one of:
a shared gaming experience, a shared leaderboard, a shared progressive prize award, a tournament experience, or a shared multimedia experience.

19. The system of claim 17, wherein the shared state resource comprises a state machine log, and wherein the state machine log enables replay and recovery for the connected gaming process.

20. The system of claim 17, wherein the shared state resource comprises at least one of: a unique identifier (UID); a key; or a resource type.
